(19) United States
(12) Patent Application Publication
(10) Pub. No.: US 2007/0099659 A1
(43) Pub. Date: May 3, 2007

(54) Systems and Methods for Uploading Content Over a Wireless Network Using a Mobile Communication Device

(76) Inventors: Anthony Borquez, Los Angeles, CA (US); Justin Verduyn, Pasadena, CA (US)

Correspondence Address: BAKER & MCKENZIE LLP;PATENT DEPARTMENT, 2001 ROSS AVENUE, SUITE 2300, DALLAS, TX, 75201, US

(21) Appl. No.: 11/379,032

(22) Filed: Apr. 17, 2006

Related U.S. Application Data
(63) Continuation of application No. 11/265,982, filed on Nov. 3, 2005.

(51) Int. Cl. H04H 7/00; H04M 1/00

(52) U.S. Cl. 455/556.2; 455/3.06

(57) ABSTRACT

A mobile application development platform comprises a toolset configured to streamline the development process for mobile applications. The streamline development process can enable efficiencies for the development of applications such as video streaming and uploading as well as image delivery and uploading. For example, by developing a video up loading application using the development platform, the application can be customized so that it can take advantage of a particular device's resources as well as the network's resources. Accordingly, video up loading can be quick and efficient.

### RELATED APPLICATION INFORMATION

This Application claims priority as a continuation under 35 U.S.C. §120 to U.S. patent application Ser. No. 11/265,982, entitled “Systems and Methods for Delivering and Using Video Applications for a Plurality of Mobile Platforms,” filed on Nov. 3, 2005, which is incorporated herein by reference as if set forth in full.

### BACKGROUND

1. Field of the Invention

The invention generally relates to the development of applications for mobile platforms, and more particularly to systems and methods for developing applications that are compatible with a plurality of mobile platforms.

2. Background of the Invention

With recent advances in cellular telephone technology and the technology that goes into cellular telephones, cellular telephones are no longer used just for voice communication. Today's cellular telephones are used for text messaging, transmission of videos and images, and for maintaining the user's contacts and calendars in much the same way as conventional Personal Digital Assistants (PDA) used to. Cellular telephone technology has evolved in order to support these new uses. For example, today's cellular telephones include more powerful processors and higher memory densities in order to support increased functionality, such as the functionality traditionally supported by PDAs. Advances in LCD technology has led to larger screens, color screens, and the ability to display pictures and videos downloaded, or streamed to the cellular telephone. Additionally, many of today's cellular telephones also come equipped with a digital camera, or even a digital video camera that allow the user to take pictures or videos and display the pictures and videos on the cellular telephone display.

These technological advances have led to increased sales of cellular telephones throughout North America and the world. It has been estimated that by the end of 2005, there will be two billion mobile service subscribers throughout the world and it is estimated that 735 million cellular telephones will be sold in 2005. Additionally, US wireless revenue for 2004 reached 145 billion. All of these numbers should continue to grow in coming years.

To demonstrate the evolving use of cellular telephones, 47% of cellular telephone users will be able to receive video using their cellular phone by 2008. Currently, Americans send 2.5 billion text messages per month using their cellular telephones. And perhaps most telling with regard to the evolving use of cellular telephones, there were 1.5 million web logs, or (“blogs”) posted in the last two years using cellular phones. These “blogs” typically contain text, pictures, and/or video, uploaded by users to a web page using their cellular telephone.

But these advances have also created problems. For example, there are a wide variety of diverse platforms for developing applications to be deployed on cellular telephones. There are also multiple carriers each with potentially their own protocols and specifications for how information and data is transferred using a cellular telephone. Additionally, there are wide variations in hardware among the cellular telephones being used today. These variations include different screen sizes, different memory capability, varying processor speeds, etc. In fact, in North America alone, there are 145 different cellular telephone types.

All of the above variables make it difficult to design and deploy applications across multiple cellular telephone types. As a result, the market for new applications has become segmented with applications being developed on a platform-by-platform basis.

For example, two applications that are becoming more and more popular for cell phone users can demonstrate the problem inherent in having so many different cellular telephone platforms and little standardization across these platforms. These two applications are uploading of digital photos from a cellular telephone and what has become known as “video blogging”, where videos are uploaded from the cell phone to a web page where they can be accessed at a later time. In order to upload photos from a cellular telephone to a web page hosted by a leading web service, the user must first verify the “camera phone's” system requirements. First, however, the user must have registered their phone with the web server. After verifying the camera phone system requirements, the registration information for the phone will be confirmed. The user can then take a picture with their camera phone. The user can then send an email to an email account hosted by the web server with the picture attached to the email. The email will then be received by the web server and the attached picture will automatically be uploaded into a mobile upload album account associated with the registered cellular telephone.

The process of taking the picture, storing the picture, generating the email, and attaching the picture to the email in order to send the email to the web server can actually be quite time consuming. As a result, posting multiple pictures becomes burdensome. A lot of this burden could be eased if a single application for uploading pictures could be used by all cellular telephone types. But the difference in cellular telephones and the systems in which they operate prevent the use of a single application.

“Video blogging” using the same web service requires a very similar process of verifying the camera phone system requirements, and verifying the cellular telephone's registration. Next, the user can compose a “blog entry” using the cellular telephone's use interface, e.g., keypad, etc. The “blog entry” can include a photo, text, or both. The blog entry can then be attached to an email generated by the user using the cellular telephone, and the email can then be sent to the web server. Again, generating the “blog entry”, generating the email, and attaching the blog entry to the email in order to send it to the web service can be prohibitively time consuming.

A competing web service for “phone blogging” has a slightly different process, wherein the user can, for example, take a picture with the camera phone, and then send a message including the picture to a pre-determined number. The number is associated with the web service, which will then take the picture and post it on a website where it can be viewed at a later time. Other services allow the user to take a picture, create some text, and then send it to a web page or email address, from which it can be posted onto a website for later viewing. As with the above web service, these processes can still prove to be prohibitively time consuming.

Still, such services are proving to be very popular. The popularity, and therefore use of such services, could be increased even further if the prohibitive time delays involved in using such services could be eliminated. Eliminating such time delays is in large part dependent upon developing a uniform application that could be used by all cellular telephone types and in all systems.

### SUMMARY

A mobile application development platform comprises a toolset configured to streamline the development process for mobile applications. The streamline development process can enable efficiencies for the development of applications such as video streaming and uploading as well as image delivery and uploading. For example, by developing a video up loading application using the development platform, the application can be customized so that it can take advantage of a particular device's resources as well as the network's resources. Accordingly, video up loading can be quick and efficient.

In one aspect, the development platform can be used to develop a video blogging application.

In still another aspect, the development platform provides deployment technology for distributing content across multiple mobile device platforms.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example development platform configured in accordance with one embodiment;

FIG. 2 is a diagram illustrating an example process of converting an application developed in one language into an application of another language using the development platform of FIG. 1;

FIG. 3 is a flowchart illustrating an example process for developing applications using the development platform of FIG. 1;

FIG. 4 is a diagram illustrating an example content delivery system comprising a development platform, such as the platform illustrated in FIG. 1, in accordance with one embodiment;

FIG. 5 is a diagram illustrating an example content delivery system comprising a development platform such as the platform illustrated in FIG. 1, in accordance with another embodiment;

FIGS. 6-20 are screenshots illustrating example screens that can be displayed on a mobile communication device as well as on a website in relation to a vlogger application developed using the development platform of FIG. 1;

FIG. 21 is a diagram illustrating an example communication system that can be configured to provide blogging service in accordance with one embodiment;

FIGS. 22-31 are screenshots illustrating example screens that can be displayed by a backend mobile ad management system included in the system of FIG. 21.

FIG. 32 is a screen shot illustrating the customizing of a generic ad campaign for users within a certain geographic area.

### DETAILED DESCRIPTION OF THE PREFERRED EMBODIMENTS

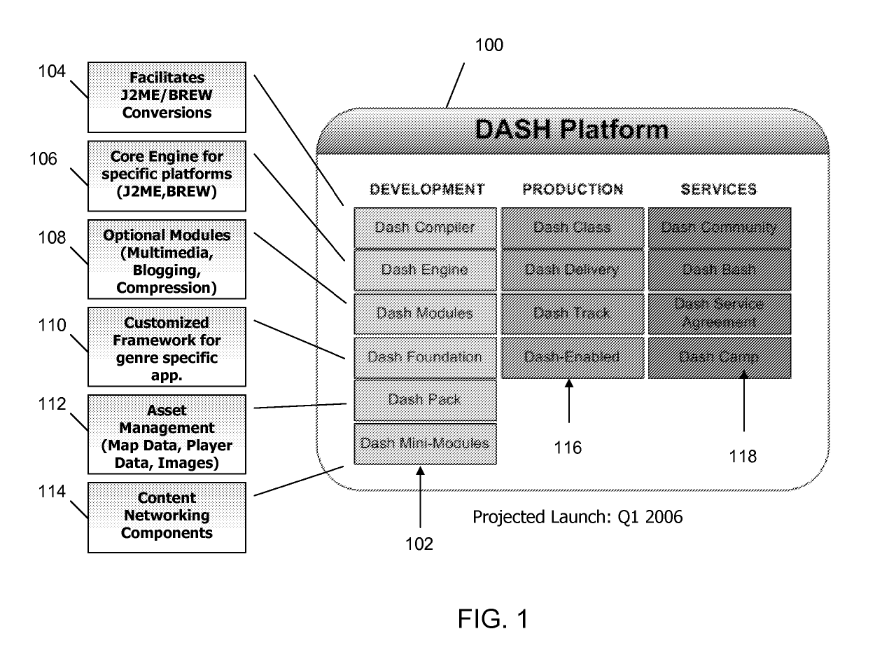

FIG. 1 is a diagram of a development platform 100 that can be configured to allow an application to be developed and “pushed out” to any of a plurality of mobile device platforms in accordance with one embodiment of the systems and methods described herein. The term “mobile device” as used in the following description and claims that follow is intended to refer to any type of mobile communication device, including traditional cellular telephones, PCS telephones, smart phones, PDA devices that include cellular or PCS communication capability, or any other portable device that can be used for voice communication. Thus, while the term “mobile device” is used in the description of the embodiments below, the use of this term should not be seen as limiting the embodiments to any particular type of device or communication platform.

As can be seen, platform 100 comprises a plurality of modules that can be used in the development of device agnostic applications. In the embodiment illustrated in FIG. 1, these modules are organized into three categories. These categories are development modules 102, production modules 104, and service modules 106. Development modules 102 can be used to enable the development of applications that are compatible with any of the various development platforms currently supported by the many mobile device types in existence. Production modules 104 can be used to allow delivery of the applications developed using development modules 102 across a wide variety of mobile device platforms. Service modules 106 can be used to enable the provisioning and tracking of services related to the applications developed using development modules 102 and delivered using production module 104.

Development modules 102 include a compiler module 104 which can be configured to compile an application developed in one of the plurality of standard languages and facilitate conversion of the application into other applications so that the application can be supported by a plurality of platforms.

Development modules 102 also include a core engine module 106, which can be configured to take the code compiled by compiler module 104 and generate code that is compatible for a platform that supports a language different from the language that the original application is written in.

Development modules 102 also comprise optional module 108, which can be configured to optimize the applications developed using core engines 106. For example, optional modules 108 can be configured to optimize the application for multimedia applications, “blogging” applications, and various compression techniques.

Development modules 102 also include a foundation module 110 which are configured to customize the application for a genre-specific application. For example, if the application is a game, foundation module 110 can customize the game for the various platforms.

Development modules 102 can also include an asset management module 112. Asset management module 112 can be configured to manage assets associated with specific applications. For example, in gaming applications, asset management module 112 can be configured to allow the application to manage information, such as map data, player data, and images associated with the game.

Development modules 102 can also include a content networking component 114, which can be configured to enable or optimize content networking between components of the application.

Platform 100, and the modules that comprise platform 100, are configured to enable an application to be written in one standard language and then converted, in an economical fashion, to other languages so that the application can be “pushed out” to as many mobile device platforms as possible.

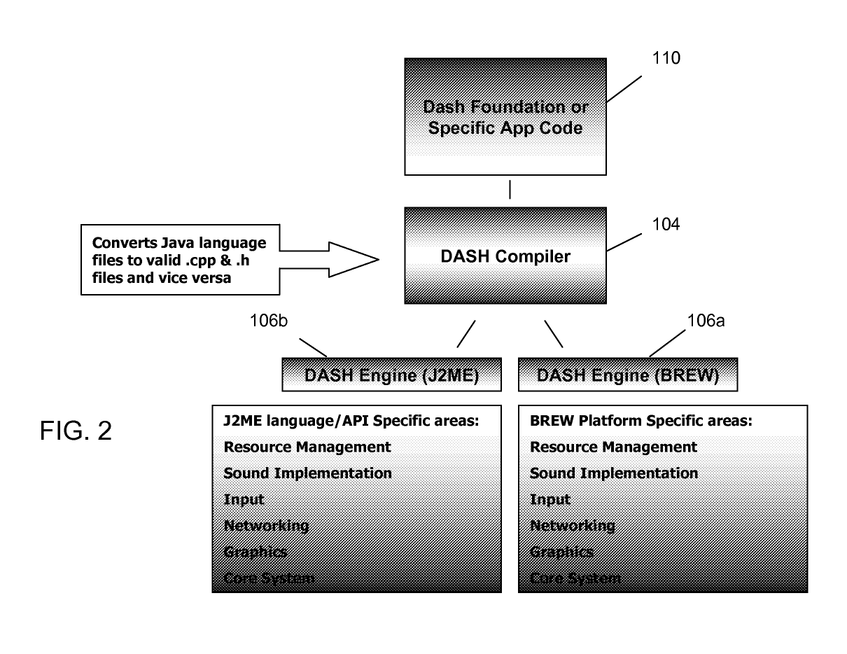

FIG. 2 is a diagram illustrating the process of converting an application developed in one language into an application of another language. Thus, in FIG. 2 an application that is written in a foundation or a specific app code 110 can be provided to compiler, module 104. For example, the foundation language can be java. The java language application 110 can then be provided to compiler 104 which is configured to convert java language application 110 files into valid files in a standard language such as C or C++. Thus, compiler 104 can convert the java language application 110 into valid .cpp and .h files.

The files developed by complier 104 can then be provided to engine modules 106. Each engine module 106 can be configured to convert the files provided by complier module 104 into the standard language associated with the specific engine module. In the example of FIG. 2, compiler 104 provides the files to two engine modules 106a and 106b. Engine 106a can be configured to convert the files into a BREW platform-specific application. Engine 106b can be configured to convert the file to a J2ME language-specific application.

The applications generated by engines 106a and 106b can, for example, then be delivered to BREW and J2ME mobile device platforms, e.g., using production modules 104.

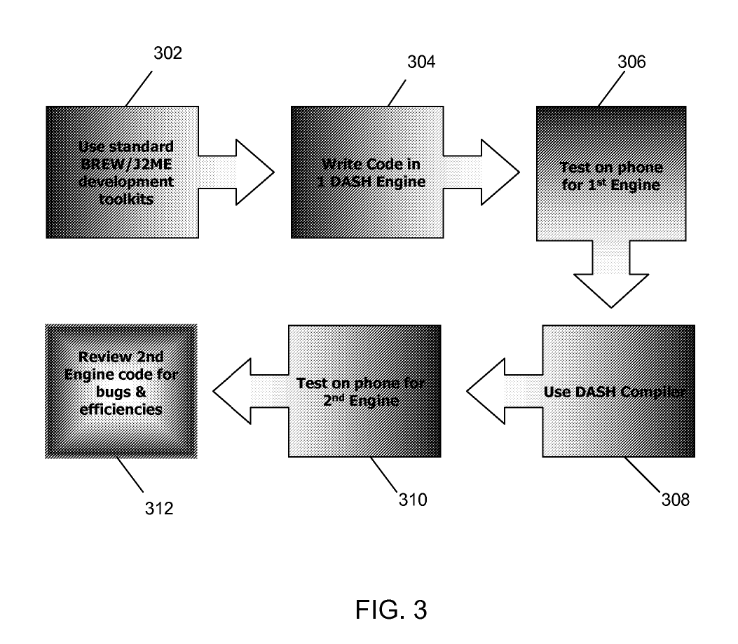

FIG. 3 is a flowchart illustrating the process for developing applications using platform 100 that can be “pushed out” to a plurality of mobile device platforms. Thus, in step 302, standard language development kits, such as BREW or J2ME development toolkits, can be used to develop applications. In step 304, the applications can be converted to a code supported by one of the engine modules 106.

This code can then be tested on a mobile device in step 306. If the testing is successful, then the code can be supplied to compiler module 102 in step 308. Compiler module 102 will convert the code into a code supported by a second engine module 106. This code can then be tested on a mobile device in step 310. If the testing is successful in step 310, then the code developed for the second engine 106 can be reviewed for bugs or inefficiencies, in step 312.

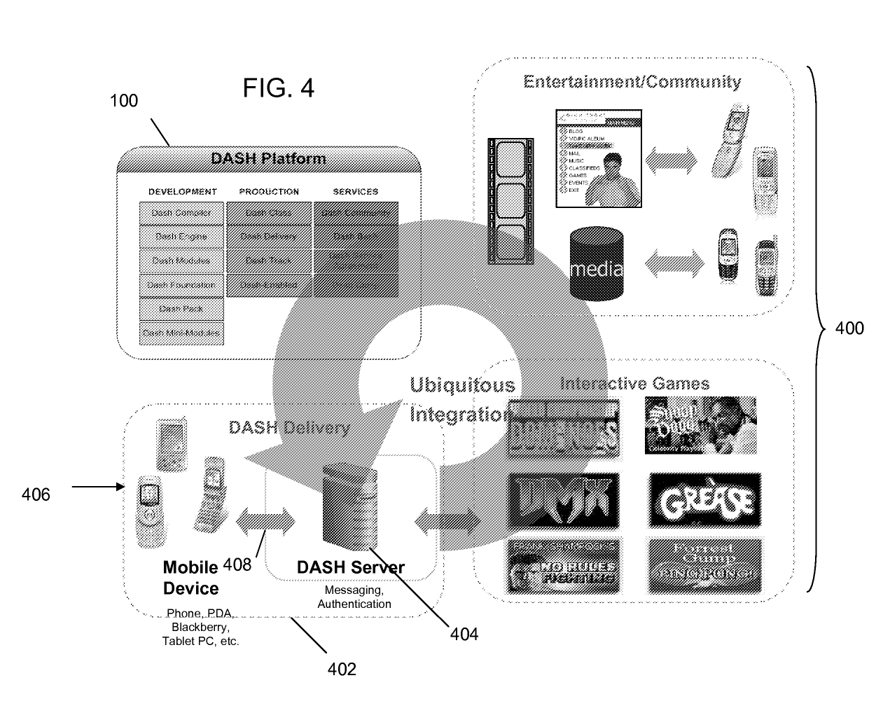

As illustrated in FIG. 4, platform 100 enables the integration and delivery of an unlimited amount of content 400 across a plurality of mobile platforms 406 via delivery system 402. Delivery system 402 comprises a deliver authority 404 configured to communicate with mobile devices 406 over communication channel 408. Applications developed using platform 100 can be “pushed out” to mobile devices 406, e.g., using server 404. The applications can be configured to enable devices 406 to receive content 400, which can also be delivered via server 404. Because the applications are developed using the standardized modules comprising platform 100, content 400 can be pushed out in an economical and efficient manner. Moreover, the content is not segmented, e.g., all content can be received and used by all mobile devices 406. In other words, the content is not segmented, where certain content is designed for certain devices 406 and not for other devices 406.

The process of FIG. 3 ensures that the content can be received and used by applications residing on all mobile devices 406. Accordingly, platform 100 can be incorporated into a mobile content deployment platform that can be used to take any kind of content and push it out to any type of mobile device.

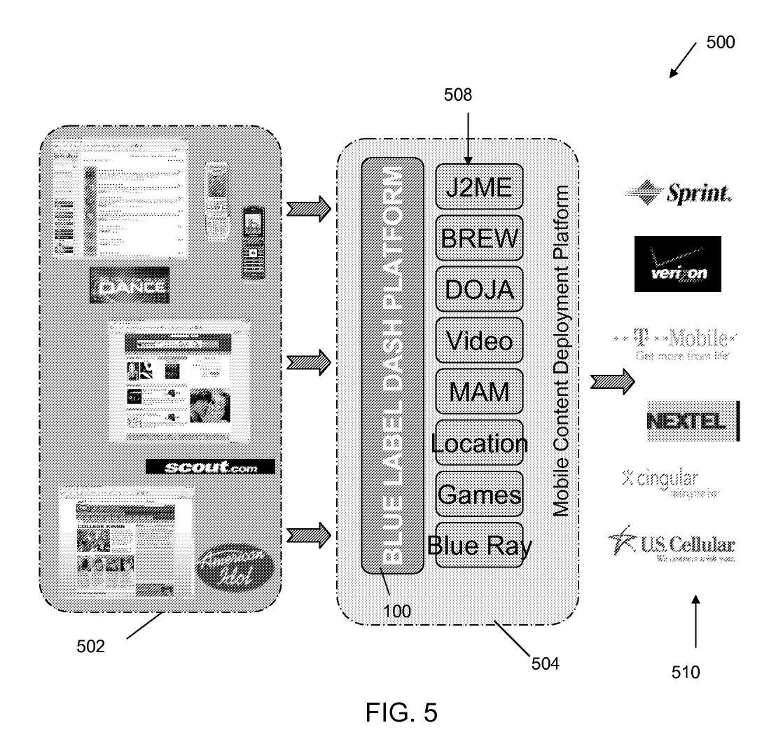

FIG. 5 is a diagram illustrating a content delivery system 500 comprising a mobile content deployment platform 504 that includes a development platform 100. Thus, mobile content deployment platform 504 can take content 502 and push it out to mobile devices 508 regardless of the type of content 502 or the type of device 508. Deployment platform 504 can accomplish this because development platform 100 can be used to develop applications that comply with any of a plurality of languages, protocols, or standards 508.

In other words, development platform 100 can be used to develop applications that comply with the requirements of the different platforms 508 and that can be configured to use or take advantage of content 502. These applications can then be pushed out to devices 508. Content 502 can then be provided to devices 508 via deployment platform 504 as well. In other embodiments, content 502 can be provided to devices 508 through an alternative platform or server or service.

For example, one type of application that can be developed using development platform 100 and pushed out to a plurality of different types of mobile communication devices 508 via content delivery system 500 is a video blogging, or “vlogger,” application.

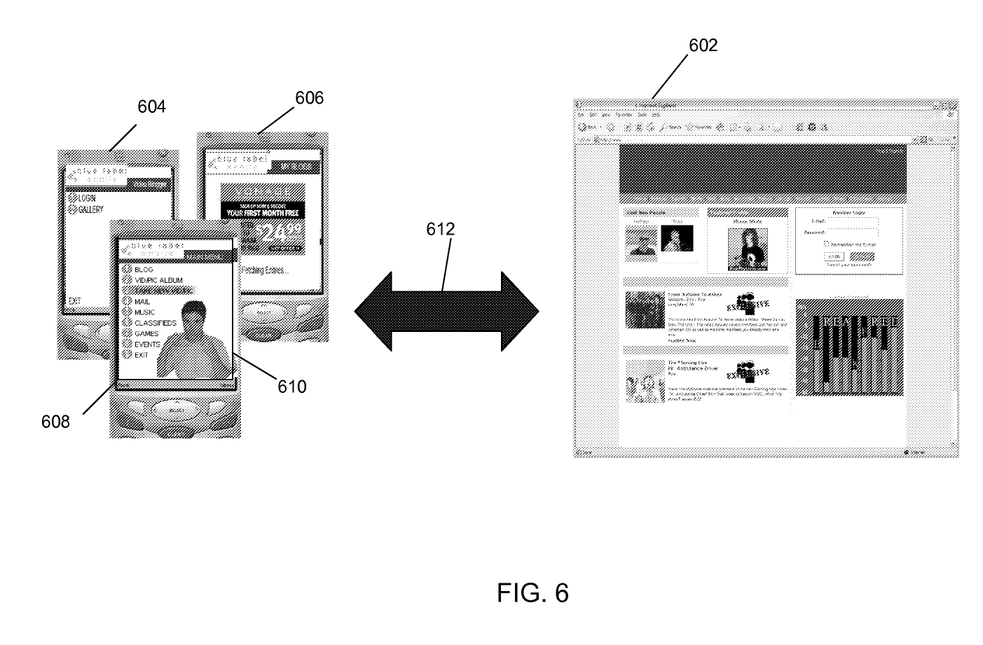

FIGS. 6-20 are screenshots illustrating example screens that can be displayed on a mobile communication device as well as on a website in relation to a vlogger application developed using development platform 100. The screenshots of FIGS. 6-17 are by way of example only, these screenshots should not be seen as limiting the systems and methods described herein to any particular type of screen size, resolution, display type, etc.

A problem with conventional blogging applications is that uploading any kind of blog content, such as a picture, video, or text, is extremely time consuming. This delay is in large part due to the fact that there are no conventional blogging applications that are resident on the mobile device. Thus, there really is no conventional blogging application for mobile communication devices. Rather, such services take advantage of a plurality of applications, such as picture capture, email, etc., resident on the device; however, because there is no resident blogging application, the devices cannot be directly interfaced with the communication network, i.e., the Internet, over which the blog content must be uploaded to a web server. As a result, the user must go through many steps to get the blog content uploaded to a web server. For example, as explained above, conventional applications require the user to store the content, create an email addressed to a web server, attach the content to the email, and then send the email. Other conventional applications can use a text message, or a call placed over the communication network. Regardless, the steps involved are time consuming especially when a lot of content is to be uploaded.

One reason that there are no conventional blogging applications is that each device, and each different network, have different protocols and procedures for accessing the Internet. Further, each mobile device can have different capabilities with regard to Internet access and performance when accessing the Internet. As a result, designers cannot design a single application that can run on any mobile device and be capable of interfacing the device with the Internet when the application is launched; however, because applications developed using development platform 100 are compatible with any device type, development platform, and network protocol, applications developed using development platform 100 can be used to interface the mobile device on which they reside with the Internet upon launching the application. In other words, the application is able to take advantage of the device resources and directly interface the device with the Internet when the application is launched.

As a result, the process for uploading content to a web server can be streamlined and the time involved greatly reduced. Essentially, when the blogging application is launched, it can cause the device to connect with the Internet and with the web server providing blogging service. The user can then simply select the content and send it quickly and efficiently, e.g., by activating a send input on the mobile device. Thus, the process for sending a picture or video can be to capture the picture or video, launch the blogging application, select the picture or video file and push send. Alternatively, the blogging application can be launched first, the picture or video captured, the captured picture or video then sent by simply pushing a send button.

It will be understood that the mechanism for indicating that the content should be sent can vary from device to device. For example, in certain embodiments, a button or keypad input can be used to indicate that the content should be sent. In other embodiments, an active input on the display can be actuated, e.g., using a finger or a stylus. In other embodiments, a menu entry can be selected in order to indicate that the content should be sent. Regardless of how the send indication is input, however, the whole process can be faster and more efficient because the blogging application is resident on the device and can take advantage of all the devices' resources.

Similarly, a blogging application developed using development platform 100 can also take full advantage of all of the network resources. As a result, content can be uploaded and downloaded at higher data rates because the application can be developed for the specific network resources and protocols.

The screenshots of FIGS. 6-20 can be used to illustrate the capability provided by applications developed using development platform 100. The screenshots of FIGS. 6-20 are related to a vlogger application and illustrate how video or picture content can be uploaded quickly and easily to a web server providing the vlogging service. Thus, a user can launch their vlogger application on their mobile device, which will cause the device to create a connection 612 with the server hosting the vlogger service. In the example of FIG. 6, as can be seen, when the vlogger application is first launched, an application screen 610 can be displayed on device 608. The screen can have a menu of options that the user can access using user interface of device 608. For example, if the user attempts to select video blogging on the menu, a display 604 can appear with a submenu as illustrated. When the user selects one of the entries in the submenu, a screen 606 can be displayed. In the example of FIG. 6, the user has selected the gallery option in screen 604 and in screen 606 an advertisement is being displayed while the device accesses the gallery information.

The vlogger application can be used to upload blog content, i.e., pictures and videos, to a web page hosted by a web server providing the vlogger service. Screenshot 602 is a screenshot illustrating a web page that can be displayed when the user accesses the user's vlogger account from, e.g., a computer.

By using development platform 100, custom downloadable applications can be provided to, e.g., mobile device 608. Thus, an application developed using development platform 100, such as the vlogger application illustrated using screenshots 6-17, will reside locally on the mobile device. The custom downloaded application developed using development platform 100 also provides the opportunity to provide a branded experience to the user. The branded experience can comprise content displayed on device 608 that is unique to the individual user, unique to the web service, or to particular advertisers. In fact, a mobile ad management backend system can be integrated with the web service that can allow highly targeted and custom advertisement to be pushed out across a plurality of mobile devices.

A mobile ad management system is described in more detail below; however, some of the unique branding enabled by the systems and methods described herein is illustrated in screenshots 6-17. Thus, in the descriptions that follow related to screenshots 6-17 some of the mobile ad capability provided by the systems and methods described herein will be described.

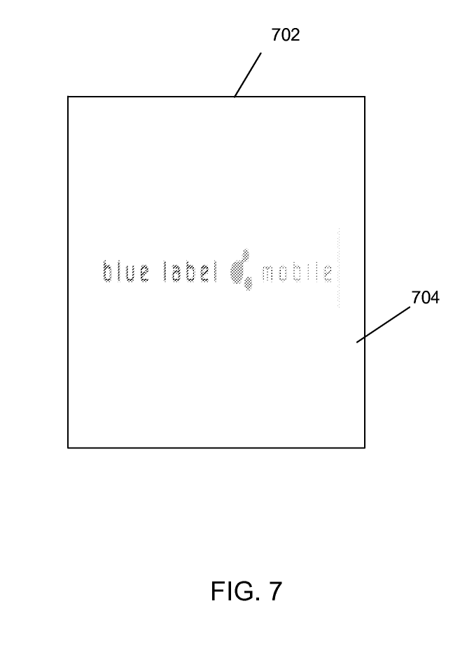

FIG. 7 is a screenshot of a display that can be displayed when a vlogger application designed using development platform 100 is first launched. As can be seen in screenshot 702, the display can comprise an advertisement 704. In this instance, advertisement 704 is an advertisement for the website hosting the vlogger web service.

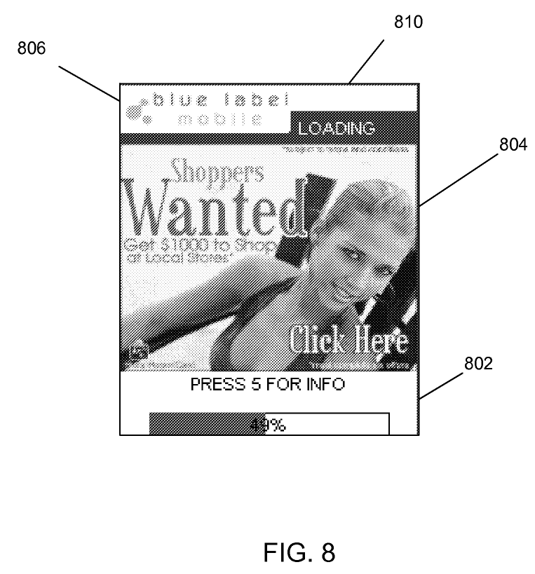

FIG. 8 is a screenshot 810 of a display that can be displayed following advertisement 704. As can be seen in screenshot 810, the display can comprise an advertisement 804. Here, advertisement 804 is for a third party product or service. The display can also comprise a status bar 802 configured to indicate the status of the vlogger application. In this case, status bar 802 indicates that the vlogger application is still loading. The display can also comprise an advertisement bar 806 configured to store a second advertisement. In this case, advertisement bar 806 contains an advertisement for the website providing the vlogger application.

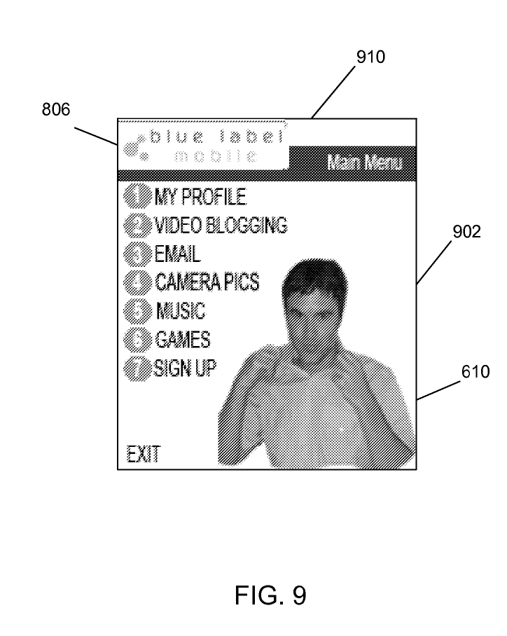

FIG. 9 is a screenshot 910 of a display that can be displayed once the vlogger application is loaded. The display can comprise a menu 902. As can be seen, menu 902 can be branded with a picture 610 or other content identifying the user. In this case, content 610 is a picture of the user.

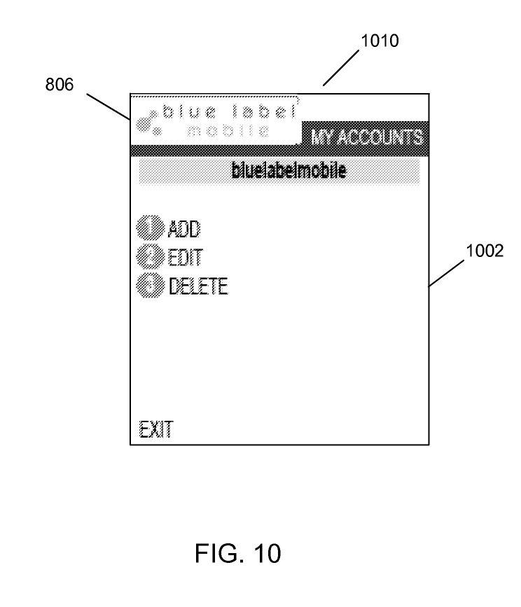

FIG. 10 is a screenshot 1010 of a display that can be displayed when one of the entries in menu 902 is selected. The display comprises a submenu 1002. In this case, the user has selected my profile in menu 902 which is taken then to a my accounts submenu 1002.

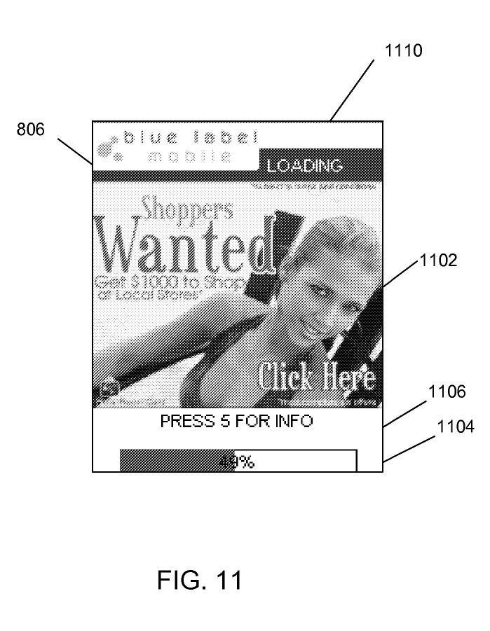

FIG. 11 is a screenshot 1110 illustrating a display that can be displayed after one of the entries in submenu 1002 has been selected. Again, while the content or application associated with the selection made in menu 1002 is loading, an advertisement 1102 can be displayed. In this case, advertisement 1102 is for a third party product of service. Status bar 1104 illustrates the progress related to loading of the application or content associated with the selected entry and menu 1002.

As can be seen, advertisement 1102 can contain dynamic links to content associated with advertisement 1102. Here, a “click here” link is shown in the bottom of advertisement 1102. Additionally, an instruction 1106 informs the user that they can press “5” on their device keypad in order to get more info related to advertisement 1102.

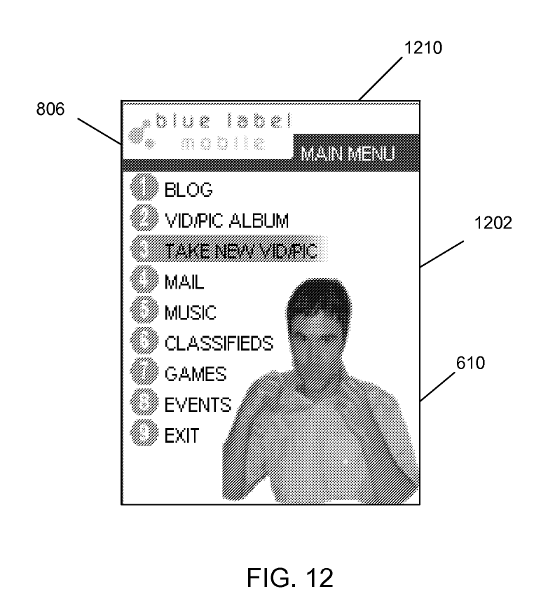

FIG. 12 is a screenshot of a display 1210 that comprises a menu 1202 associated with the vlogger application. Thus, the user can use menu 1202 in order to acquire new content and upload it to the website associated with the vlogging service.

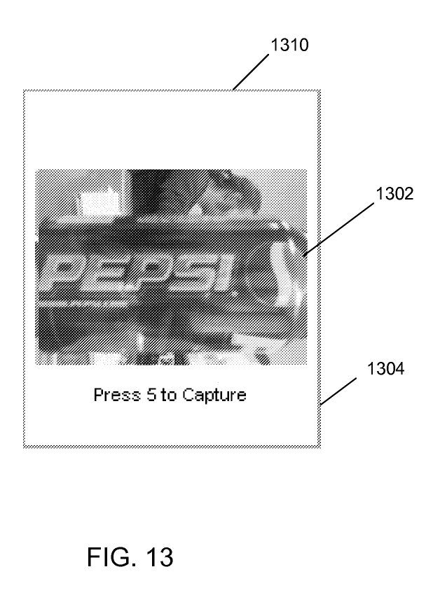

FIG. 13 illustrates a screenshot 1310 of a display that can be displayed when the vlogger application is launched an image is being acquired. Thus, an image 1302 can be displayed when a new video or picture selection is selected in menu 1202. Picture 1302 is being provided via a video camera or camera included in device 608. The display can include an instruction bar 1304 that instructs the user as to what steps to take. Here, instruction bar 1304 instructs the user to press 5 on their keypad in order to capture picture 1302.

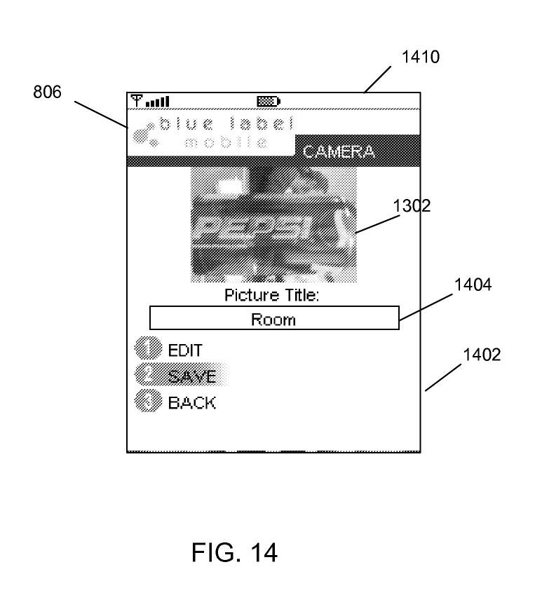

FIG. 14 is a screenshot 1410 illustrating a display that can be displayed once image 1302 is captured, e.g., by pressing 5 on the keypad. Once image 1302 is captured, it can be displayed in the upper part of the display. In addition, a menu 1402 can be displayed allowing the user to edit picture 1302, save picture 1302, or go back to another picture. In addition, the user can name picture 1302 in text input box 1404.

Once picture 1302 is named, the user can elect to save it by selecting the save entry in menu 1402. This will cause the vlogger application to upload picture 1302 to the web server.

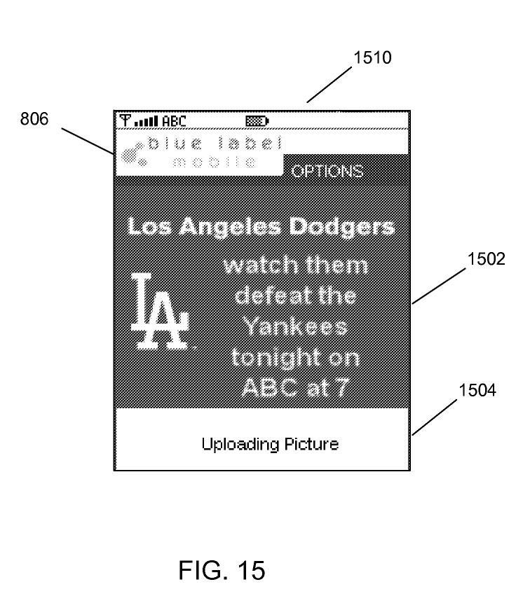

FIG. 15 is a screenshot 1510 illustrating a display that can be displayed once the save option has been selected. Again, an advertisement 1502 can be displayed while the picture is being uploaded. Status bar 1504 can provide the status of the upload procedure.

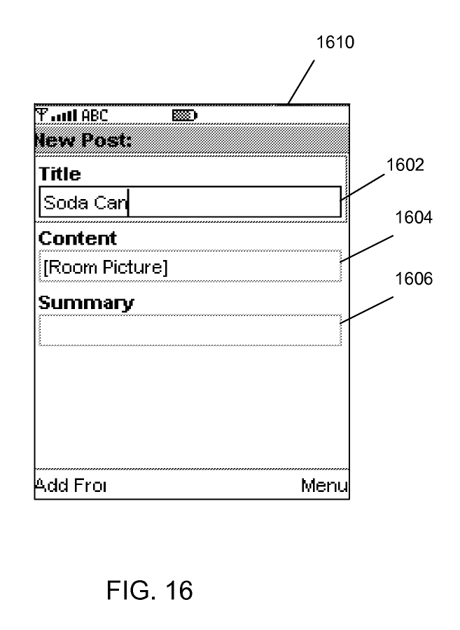

FIG. 16 is a screenshot 1610 illustrating a display that can be displayed after the user has uploaded image 1302. Display 1610 allows the user to name the picture in field 1602, describe the contents in field 1604, and add a summary for the picture in filed 1606, which will be stored on the web page.

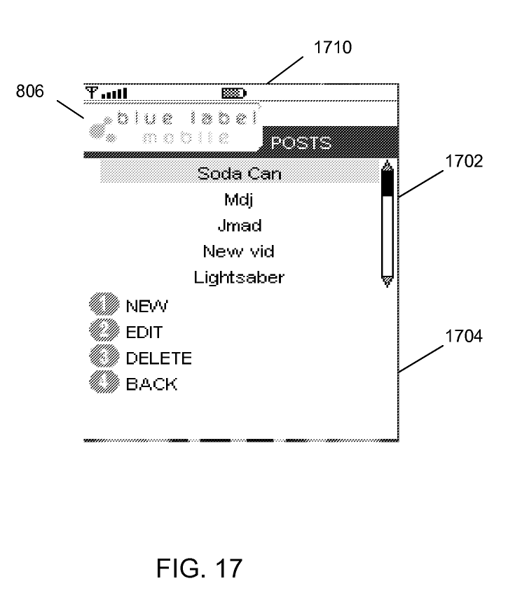

FIG. 17 is a screenshot 1710 illustrating a display that can be displayed after picture 1302 has been stored. The display includes a menu 1702 of pictures or files that have been stored on the web page. A menu 1704 allows the user to add, edit, delete, and navigate between the stored pictures or files.

Once the user has uploaded blog content, the user can then access the web page using a computer, such as a desk top or laptop computer in order to view the blog content.

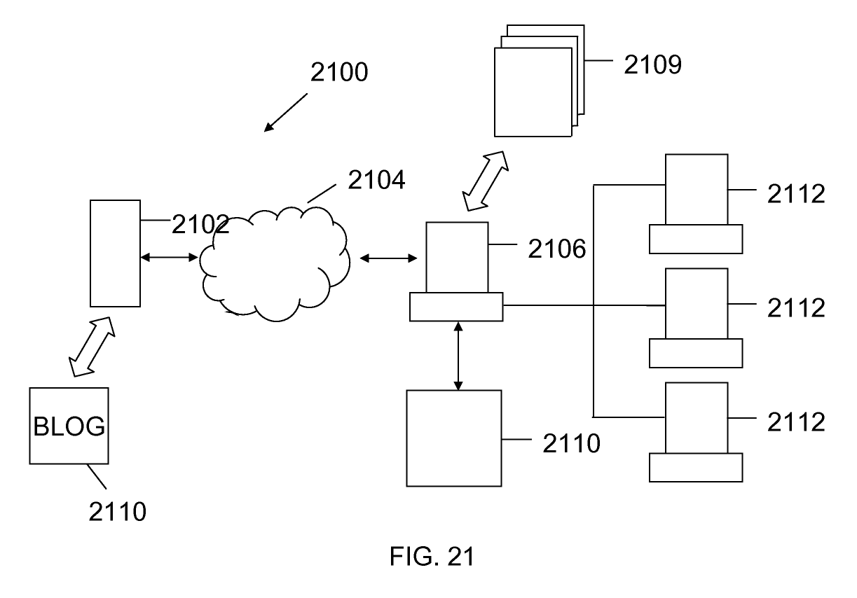

FIG. 21 is a diagram illustrating an example communication system 2100 that can be configured to provide blogging service in accordance with one embodiment of the systems and methods described herein. System 2100 can comprise a plurality of mobile communication devices 2102 comprising resident blogging applications 2120. For convenience, a single mobile communication device 2102 is shown.

Mobile communication device 2102 can upload blog content to a web server 2106 over the Internet 2104 using resident blogging applications 2120. The blog content can be associated with one of a plurality of web pages 2108 hosted by web server 2106. Users can then access web pages 2108 using computers 2112 interfaced with web server 2106 via a communication network. It will be understood that the communication network interfacing web server 2106 and computers 2112 can comprise the Internet as well. The communication network can also comprise a wired or wireless Local Area Network (LAN), wired or wireless Personal Area Network (PAN), wired or wireless Wide Area Network (WAN), wired or wireless Metropolitan Area Network (MAN), etc., or some combination thereof.

Depending on the service, only the user of mobile device 2102 can access the associated web page 2108. In other embodiments, other users can access the associated web page. Thus, access can be open to the public, or restricted, e.g., using a password, etc.

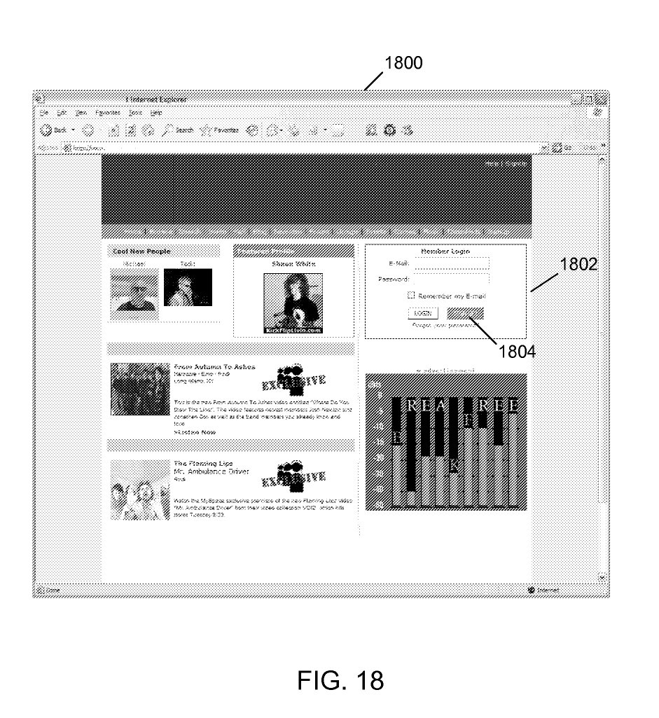

FIG. 18 is a diagram illustrating a web page 1800 that can be displayed by server 2106 when a user access web server using a computer 2112. As can be seen, web page 1800 can comprise a sign in field 1802. A registered user can provide their user ID, e.g., an email address, and password in order to access one or more web pages 2108. A new user can create an account by selecting sign up option 1804.

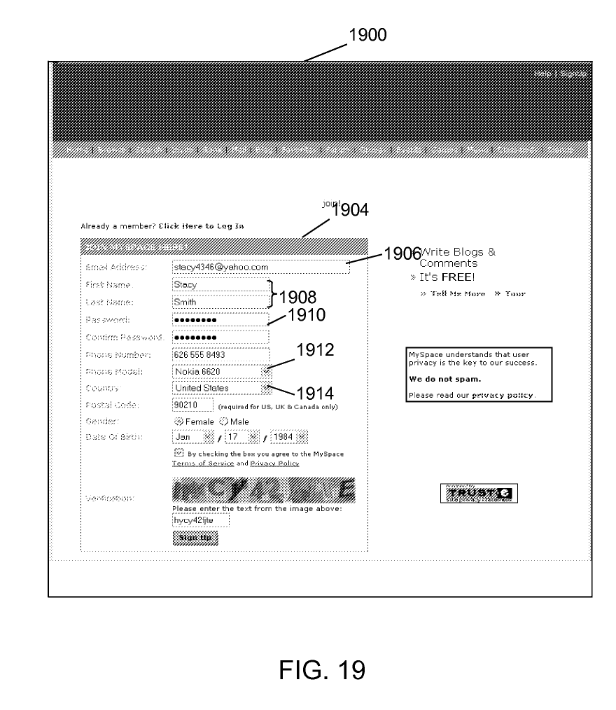

FIG. 19 is a display 1900 that can be displayed when a user has selected sign up option 1804. A sign up field 1904 can be displayed in which the user can provide an email address 1906, name 1908, password 1910, as well as the number 1912 and model 1914 of their mobile device. This information is used to download resident, custom applications developed using development platform 100 to the user's mobile device.

As illustrated in FIG. 21, and as described above, system 2100 can include a mobile ad management back-end system 2110 interfaced with web server 2106. Back-end ad management system 2110 can enable advertisers to create ad campaigns that can be pushed out to mobile devices 2102; however, because resident, custom applications have not pushed out to devices 2102 using development platform 100, the ad campaigns created using back-end mobile ad management system 2110 can provide custom advertising based on a variety of criteria. The custom ad capabilities can ensure that advertisement optimized for each device 2102 is delivered to the user, which increases the value of the ad campaign and provides customized branding.

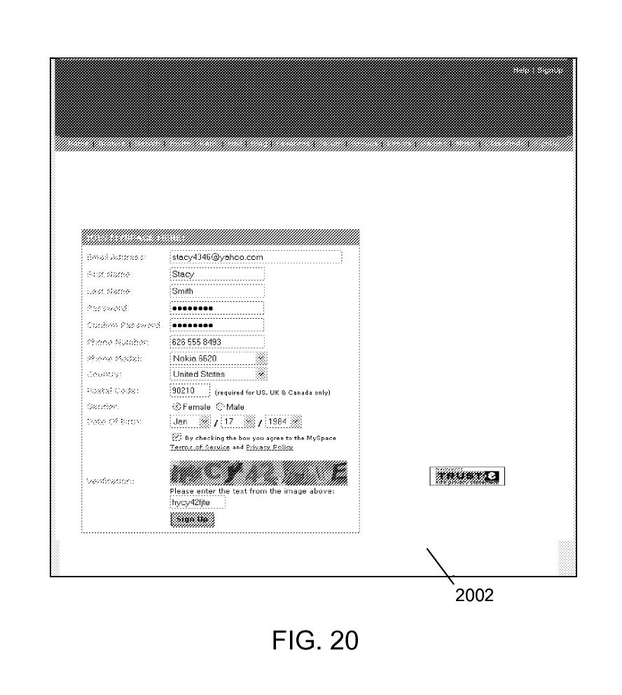

As illustrated in FIG. 20, a user can access an advertisement database using an advertise selection 2002. In certain embodiments, only authorized users can access the advertisement database. In other embodiments, anyone who wants to sign up as an advertiser can access the advertisement database. Generally, the content access via advertise selection 2002 is restricted to advertisement associated with the user.

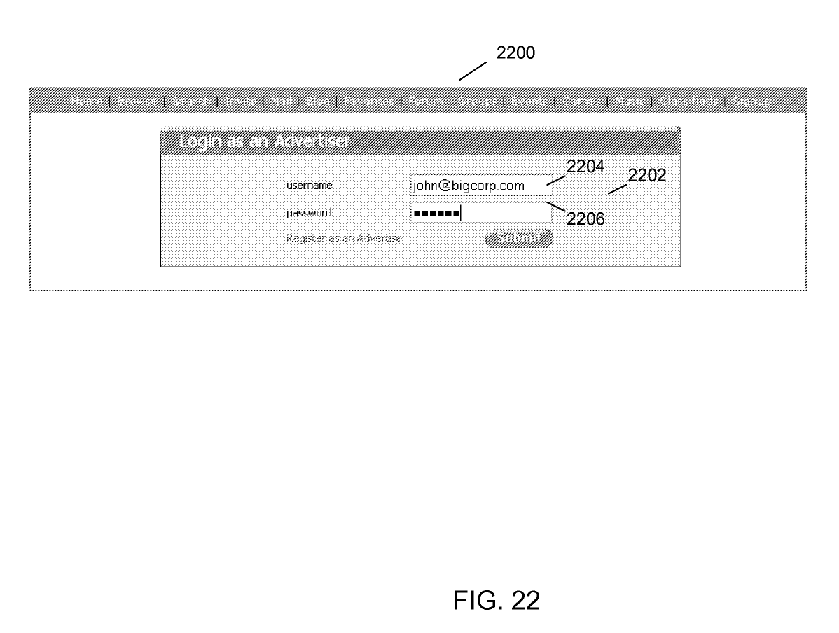

FIG. 22 is a screenshot 2200 illustrating a display that can be displayed on the users' computer when the user select advertise selection 2002. As can be seen, the display can include an advertiser login field 2202, in which the advertiser can supply an ID, or username 2204, such as an e-mail address, and a password 2206.

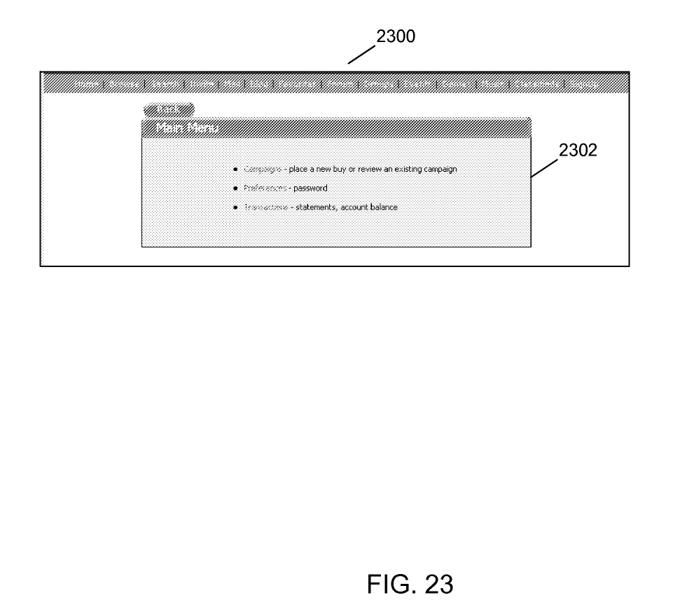

FIG. 23 is a screenshot 2300 illustrating a display that can be displayed once the advertiser is successfully logged in. As can be seen, the display can include a menu 2302 that provides the advertiser several options. These options can include the ability to create a new advertising campaign or review an existing campaign, change the password or user ID, and review the advertiser's account with the web service.

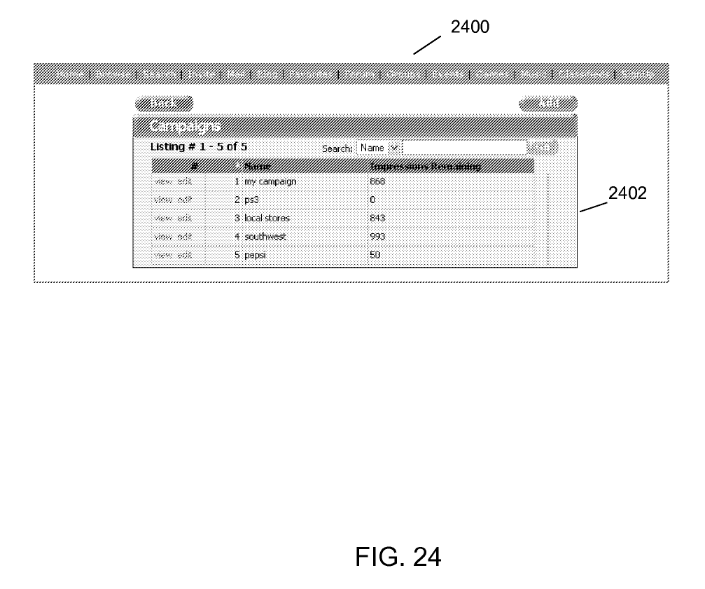

FIG. 24 is a screenshot 2400 illustrating a display that can be displayed when the advertiser selects the campaign option in menu 2302. As can be seen, the display includes a list 2402 of current campaigns. The advertiser can scroll through the list and select the campaign to review.

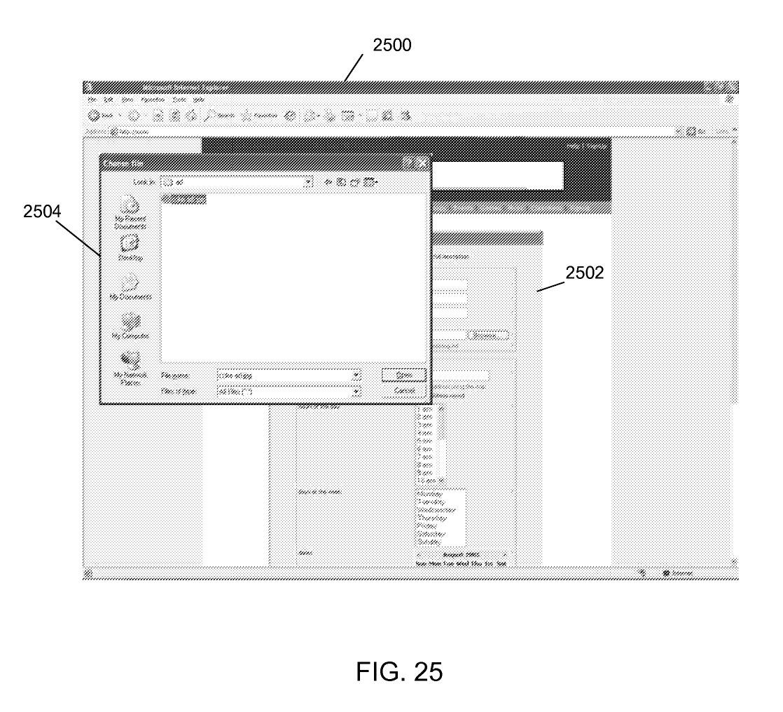

FIG. 25 is a screenshot 2500 illustrating a display that can be displayed once the user has selected a particular campaign. The display includes an advertising information field 2502.

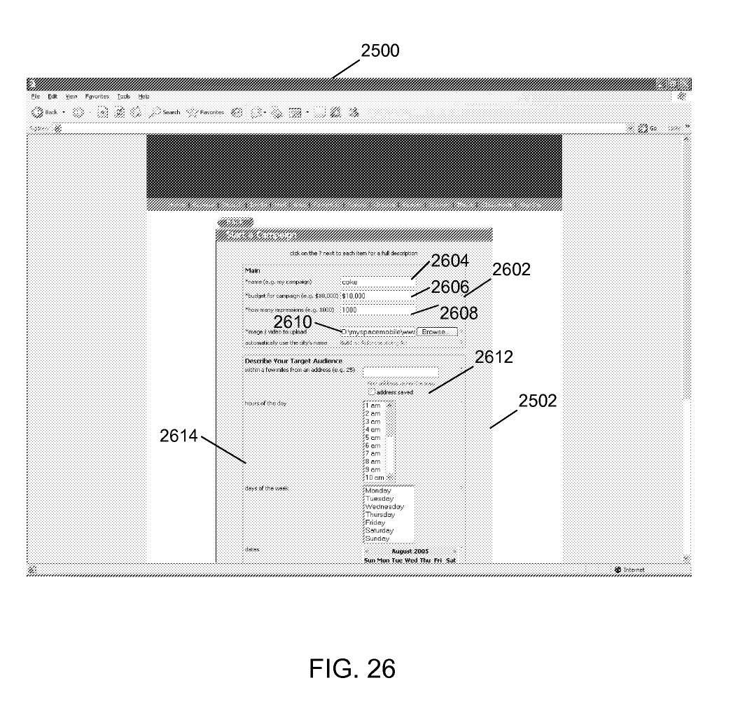

FIG. 26 illustrates this information field 2502 in more detail. As can be seen, information field 2502 can include a main information field 2602 that includes information, such as a name of the company 2604, the budget for the advertising campaign 2606, the number of impressions, e.g., viewings 2608 desired, and an image 2610 to be associated with the ad campaign. When the advertiser selects a particular image or video file for the campaign, a sub-window 2504 can pop up allowing the advertiser to select the image or video file.

Information field 2502 can also include a field 2614 that includes information regarding the target audience for the ad campaign. As can be seen, field 2614 can include a tool that allows the advertiser to select certain addresses for the targeted campaign.

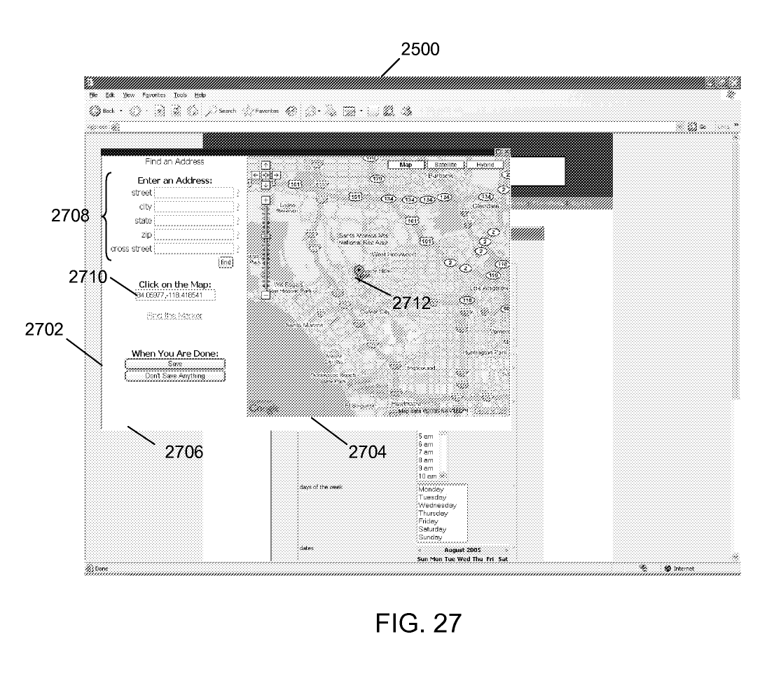

FIG. 27 is a screenshot illustrating an address field 2702 that can pop up when the user selects address to a 2612 in field 2614. Address field 2702 can include a map section 2704 as well as an address field 2706 in which the advertiser can input address information in fields 2708. Alternatively, the advertiser can simply select coordinates 2710 on map 2704. The address information input by the advertiser can be used to specify a central point 2712 on the map for an area that the advertiser wishes to designate for a targeted advertisement campaign. In other words, the user can select the center point 2712 and then specify a range around center point 2712 for the targeted advertising campaign. The range can, for example, be specified as a number of miles from the center point.

In other embodiments, the advertiser can simply specify a zip code on the map. The advertisement campaign can then be customized for the area code. Other geographic designations can also be used. For example, depending on the embodiment, area codes, city boundaries, etc., can be used alone or in combination with other designations.

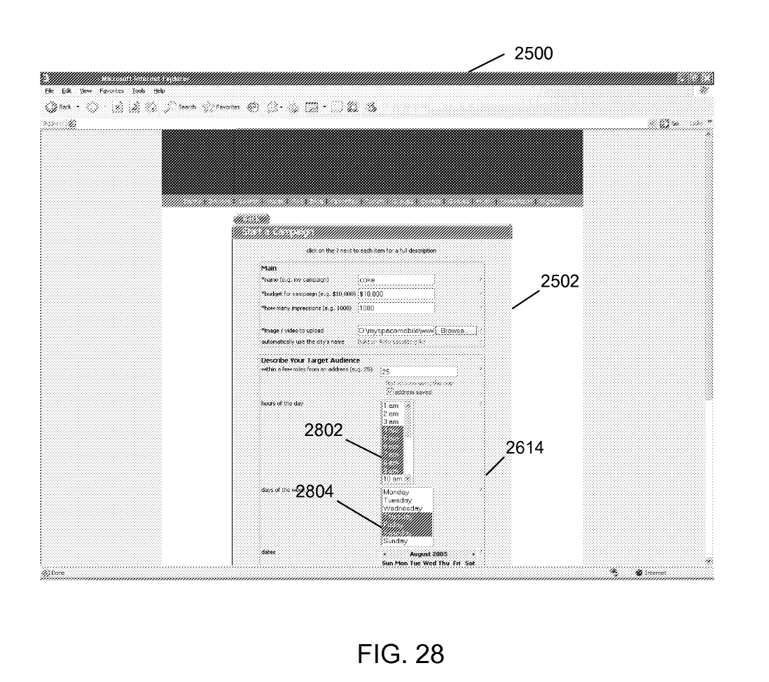

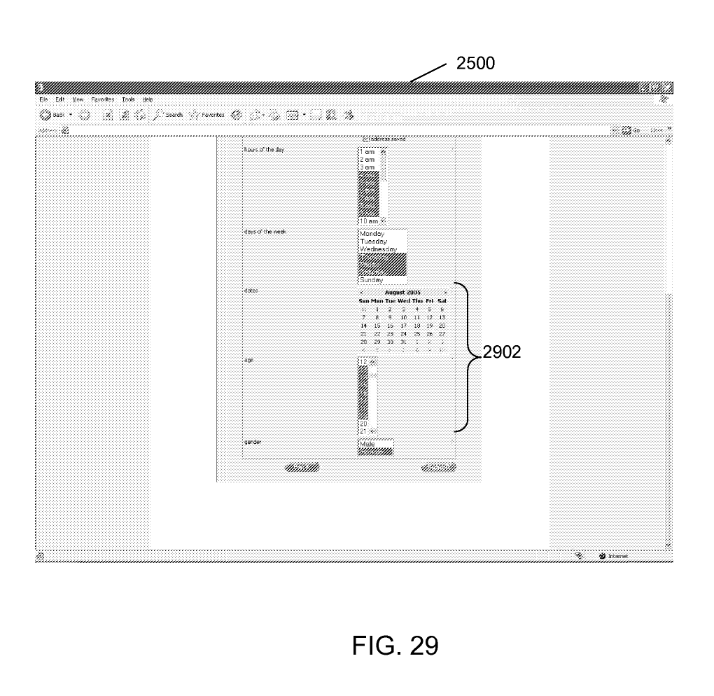

As illustrated in FIG. 28, field 2614 can also include fields 2802 and 2804 allow the advertiser to select the time and days, respectively, during which the advertising campaign will be active. As illustrated in FIG. 29, field 2804 can expand in order to allow the advertiser to select days on the calendar in fields 2902.

Thus, using the tools provided via back-end mobile ad management system 2110, an advertiser can generate targeted ad campaigns. The ad campaigns themselves, e.g., the advertisement content, can then be constructed for delivery using development platform 100. As illustrated in FIG. 5, content 502 can be converted into any of a plurality of development platforms, protocols, etc., using development platform 100. As a result, the content delivered to each user can be customized for viewing using a resident, custom application that resides on the user's mobile device 2102. The content can be pushed out to users as part of a separate application, e.g., a vlogger application. Alternatively, the content can simply be downloaded using a resident, custom video streaming or content downloading application resident on the user's device 2102. Video streaming and content downloading applications are described in more detail below.

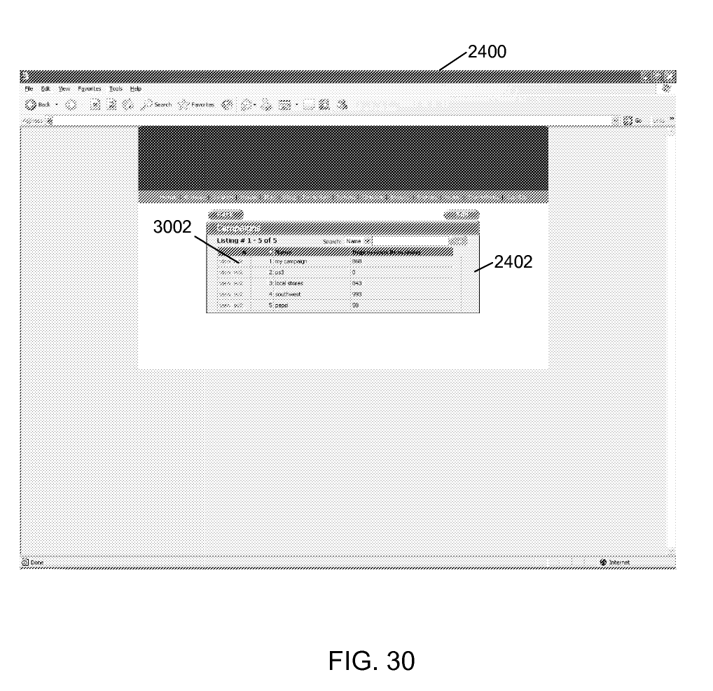

FIG. 30 is a screenshot illustrating how the advertiser can create custom content for a custom advertisement campaign using the edit selection 3002.

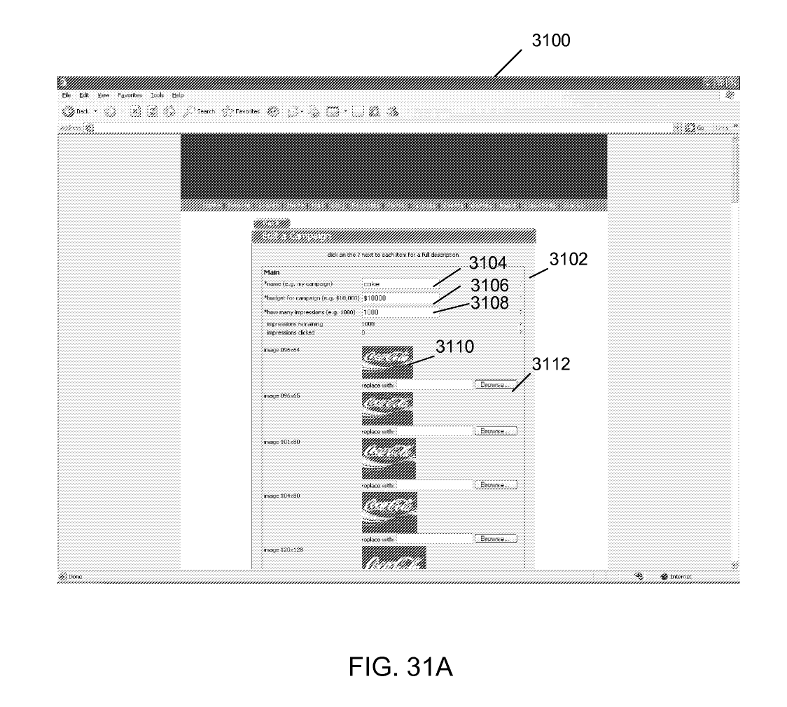

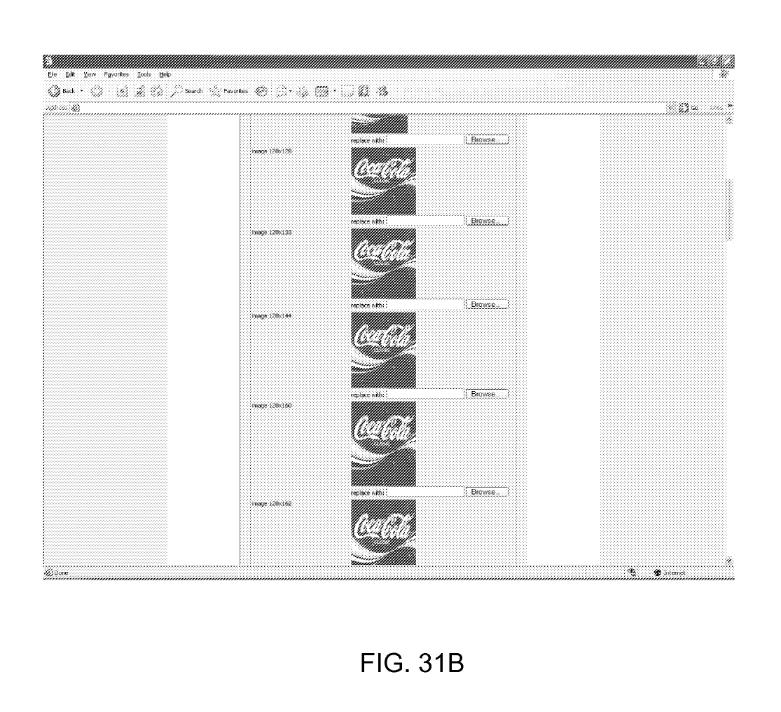

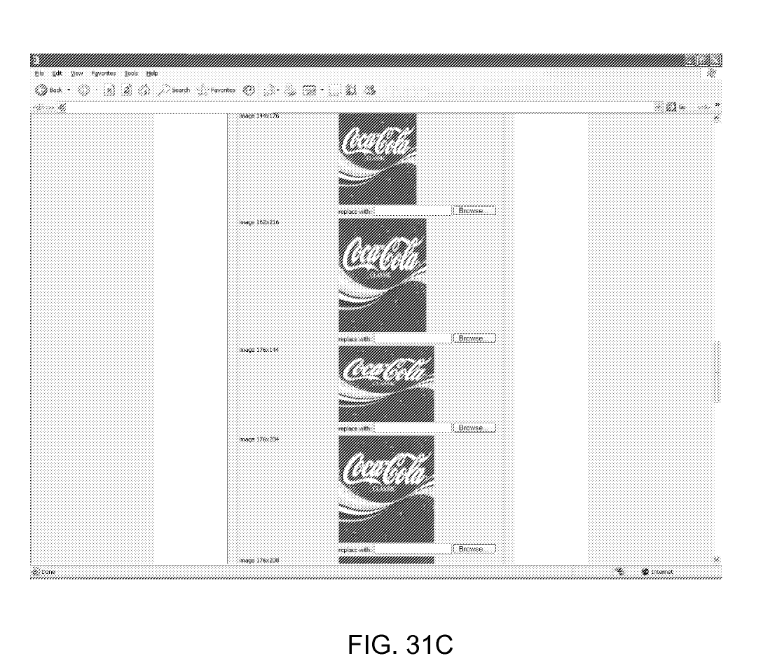

FIG. 31A is a screenshot of 3100 illustrating a display that can be displayed when an advertiser has selected the edit selection 3002. The display includes a campaign edit field 3102 in which the advertiser can change the name of the campaign 3104, budget 3106, desired impressions 3108, and the image 3110 associated with the campaign.

The advertiser can use toolbar 3112 in order to select the new image 3110. Once image 3110 is selected, however, it can be automatically reformatted into formats associated with the various device types, and display types included therein. As a result, image 3110 can be replicated into a plurality of images of different sizes and resolutions as illustrated in FIGS. 31A-31C. The image replications are possible because design platform 100 includes information associated with each device and display type. The user can be allowed, depending on the embodiment, to actually change images on a more granular scale. In other words, for smaller displays the advertiser could select a certain image 3110, but use a different image for larger displays. Thus, a toolbar, such as toolbar 3112 can be associated with each of the images in FIGS. 31A-31C.

Development platform 100 can also be configured to customize an ad campaign based on location information for mobile device 2102. In other words, a generic advertising campaign can be created, then depending on the address information provided, users within a specific area can be given a customized version of the ad campaign.

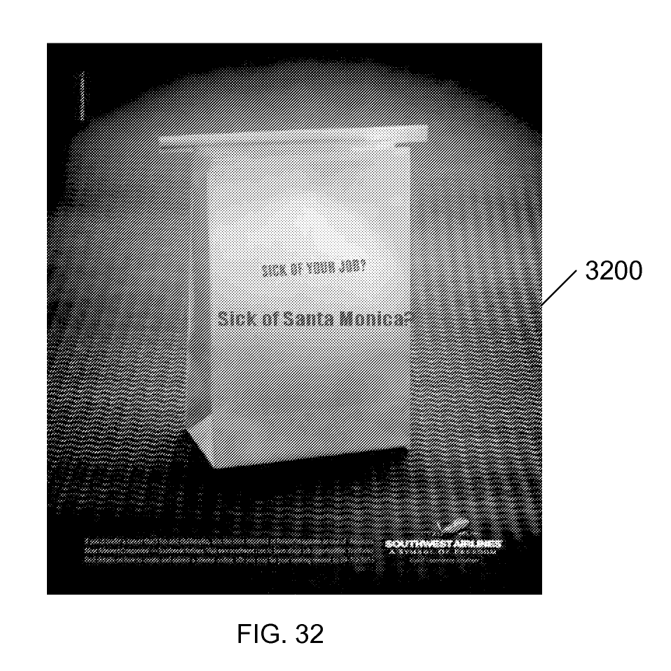

FIG. 32 illustrates the customizing of a generic ad campaign for users within a certain geographic area. Obviously, users in another geographic area would see a slightly different ad 3200.

As mentioned above, development platform 100 can also be used to develop and deploy resident, custom video streaming and/or content downloading applications. Conventional streaming and downloading applications are either limited, because the developer has to develop a generic application that is then pushed out to a plurality of devices, or because the developers are forced to develop a custom application for a single device. As a result, it is difficult to develop applications that are customized for all device types; however, because platform 100 can effectively, and efficiently develop applications that are customized for each device type, e.g., using the development process of FIGS. 2 and 3, a video streaming and/or content downloading application can be customized and verified for each device platform. As a result, higher data rates, greater resolution, and superior viewing quality can be achieved using development platform 100 to develop and deploy resident, custom video streaming and/or content downloading applications.

Thus, using the systems and methods described above, custom downloadable applications can be created and deployed to a plurality of different device types quickly and efficiently. Exemplary applications include video uploading and streaming applications and image uploading and downloading applications. Further, the ability to deploy customized applications using the systems and methods described above can allow for custom ad management.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. In a mobile communication device comprising a content up loading application customized for the mobile communication device, a method for uploading content, comprising:
The mobile communication device launching the content up loading application;
the content up loading application automatically accessing mobile communication device resources and connecting with a web server over a wireless communication network using the mobile communication device resources;
the mobile communication device receiving a selection of content to be uploaded;
the mobile communication device loading the selected content; and
the mobile communication device sending the loaded content to the web server, without any other intervening steps, using the mobile communication device resources.

2. The method of claim 1, wherein the content uploading application resides locally on the mobile communication device.

3. The method of claim 1, further comprising acquiring the content using the mobile communication device resources.

4. The method of claim 3, wherein the content is video content acquired using a video camera and a video acquisition application resident on the mobile communication device.

5. The method of claim 3, wherein the content is image content acquired using a camera and an image acquisition application resident on the mobile communication device.

6. The method of claim 3, wherein the content is text acquired using a text input mechanism and a text acquisition application resident on the mobile communication device.

7. The method of claim 3, further comprising storing the acquired content on the mobile communication device.

8. The method of claim 1, further comprising displaying an ad to while the selected content is loading.

9. The method of claim 1, further comprising displaying an ad while the loaded content is sent.

10. A mobile communication device, comprising:
a content acquisition device;
a content application program configured to acquire content using the content acquisition device;
a communication device;
a communication application configured to communicate with a web server over a wireless network using the communication device;
a content up loading application customized for the mobile communication device, the content up loading application configured to automatically accessing the communication application and connect with the web server over the wireless communication network in order to upload selected content acquired via the content acquisition application and device.

11. The mobile communication device of claim 10, wherein the content uploading application resides locally on the mobile communication device.

12. The mobile communication device of claim 10, wherein the content is video content and the content acquisition device is a video camera.

13. The mobile communication device of claim 10, wherein the content is image content and the content acquisition device is a camera.

14. The mobile communication device of claim 10, wherein the content is text and the content acquisition device is a text input mechanism.

15. The mobile communication device of claim 10, further comprising memory configured to store the acquired content on the mobile communication device.

16. The mobile communication device of claim 10, further comprising a display configured to display an ad to while the selected content is loading.

17. The mobile communication device of claim 10, further comprising a display configured to display an ad while the loaded content is sent.

18. The mobile communication device of claim 10, further comprising a user interface configured to enable the mobile communication device to receive an input instructing the device to launch the content uploading application and to receive a content selection.

19. The mobile communication device of claim 18, wherein the content up loading application is configured to receive a content selection, load the content selection, and up load the loaded content using the communication application and device without any other intervening steps.
